(19) United States
(12) Patent Application Publication
(10) Pub. No.: US 2025/0155955 A1
(43) Pub. Date: May 15, 2025

(54) REGION-AWARE POWER & ENERGY REGULATION

(71) Applicant: HEWLETT PACKARD ENTERPRISE DEVELOPMENT LP, Spring, TX (US)

(72) Inventors: Anna Yazhi Yue, Bloomington, MN (US); Torsten Wilde, Koenigs Wusterhausen (DE); Sanyam Mehta, Eden Prairie, MN (US)

(21) Appl. No.: 18/388,573

(22) Filed: Nov. 10, 2023

(51) Int. Cl. G06F 1/329

(52) U.S. Cl. CPC G06F 1/329

(57) ABSTRACT

A region-aware power/energy regulation method comprises periodically identifying a region of an application which is currently being executed by a given processor out of a plurality of regions of the application. The method also comprises measuring the instructions per second (IPS) of the given processor during execution of the identified region. The method also comprises determining a compute-boundedness parameter of the identified region based on the measured IPS. The method also comprises determining an optimal frequency for the identified region based on the compute-boundedness parameter thereof, and instructing the given processor to set a frequency of the given processor to the optimal frequency during execution of the identified region.

### INTRODUCTION

Electricity consumption and efficiency is becoming an increasingly important concern for computing devices. Electricity consumption may be quantified in terms of electrical power consumption and electrical energy consumption. Electrical power consumption refers to the instantaneous power draw (voltage multiplied by current), measured in Watts (W) or similar units. Electrical energy consumption refers to the integration of the electrical power consumption across time, e.g., measured in Joules (J), Watt-hours (W·h), or similar units.

Generally, it is desired to improve the electrical power efficiency and the electrical energy efficiency of computing systems. This is particularly true with high-performance computing (HPC) systems. HPC systems aggregate computing power to deliver significantly higher performance than can be achieved by a typical solitary computer or workstation. Often, HPC systems network multiple computing devices, also referred to as nodes, together to create a high-performance architecture. Applications are executed concurrently on the networked computing devices resulting in increased performance relative to that which could be achieved by a single device. Because of the high performance of such HPC systems, they tend to have very high electrical power/energy demands, and these demands are expected to increase as systems become more performant and HPC jobs become larger and/or more complicated.

The power demand of HPC systems (or other computing systems) can have some negative side effects. For example, systems with high electricity consumption needs may have higher upfront costs and higher ongoing operating costs. The upfront costs of the high-power systems may be higher because they may need to be provided with more performant power supply units and cooling solutions to accommodate the power demand. The operating costs may also be higher due to the cost of the electricity itself (particularly in locations with high electricity costs), and also due, potentially, to needing to supply more coolant to the system during operation and/or to cool the coolant to lower temperatures. In addition, the consumption of large amounts of electricity by HPC systems can raise regulatory or environmental concerns. Thus, improvements in electrical efficiency are needed in computing systems, and particularly in HPC systems.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 is a block diagram schematically illustrating an example information processing system configured to execute a region-aware power/energy regulator.

FIG. 2 is a block diagram schematically illustrating an example compute node configured to execute a region-aware power/energy regulator.

FIG. 3 is a block diagram schematically illustrating an example HPC system comprising an HPC system control node configured to execute a region-aware power/energy regulator.

FIG. 4 is a process flow diagram illustrating an example method of region-aware power/energy regulation.

FIG. 5 is a process flow diagram illustrating another example method of region-aware power/energy regulation.

FIG. 6 is a process flow diagram illustrating an example method of adjusting uncore frequency as part of region-aware power/energy regulation.

FIG. 7 is a process flow diagram illustrating an example method of determining if a region needs to be characterized as part of region-aware power/energy regulation.

FIG. 8 is a block diagram schematically illustrating an example non-transitory computer readable medium comprising region-aware power/energy regulation instructions.

### DETAILED DESCRIPTION

One of the largest consumers of electrical power/energy in a computing device is the processor (e.g., CPU). Thus, one way to reduce the overall electricity consumption of a computing device or system of multiple computing device (e.g., HPC system) is to adjust the operating parameters of the CPU(s) to consume less power. In particular, one CPU parameter that can be adjusted to save electricity is the CPU core clock frequency. Specifically, some approaches to saving power reduce the CPU frequency to a value lower than a normal operating value, which in many cases will reduce the amount of electricity consumed (to a lesser or greater extent, depending on circumstances, as will be described below).

Although reducing CPU frequency can reduce electricity consumption, it can also degrade system performance. In other words, there is generally a tradeoff between saving electricity and system performance. In some cases, saving power at the cost of degraded performance may be considered acceptable, provided the performance degradation is minor relative to the electricity savings. However, if performance degradation is severe and/or if the energy savings are small, then the tradeoff may not be deemed acceptable. Thus, many power saving approaches that rely upon CPU frequency reduction will attempt to determine a CPU frequency that will strike a desired balance between system performance and electricity consumption. This may be referred to as “optimizing” the CPU frequency.

In practice, it can be difficult to optimize the CPU frequency to produce the desired balance between system performance and electricity consumption. This is because it is generally not known in advance exactly how much performance degradation will occur or how much electricity savings will be realized in response to a given reduction in CPU frequency. Reducing the CPU frequency by a given amount may produce different results under different circumstances, depending on what the CPU is doing at the time, i.e., depending on the current workload. For some workloads, reducing the CPU frequency a given amount may degrade performance only a little—for example, if the CPU is currently waiting on data to be transferred from memory, a reduction in a CPU core frequency will not significantly affect performance. For other workloads, reducing the CPU frequency by the exact same amount may degrade performance greatly—for example, if the CPU is currently executing a series of instructions that do not require any significant waiting for data, performance may be degraded proportionally to any reductions in frequency. Moreover, for some workloads a reduction in CPU frequency may reduce both power and energy usage, while in other cases the same reduction in CPU frequency may reduce power but have little to no effect on energy usage (or may even increase energy usage). Thus, there may not be any single CPU frequency that is optimal for all circumstances.

In particular, the response of a system to a CPU frequency reduction may vary from one application to another application. For example, certain primarily memory-bound applications such as lbm may suffer very little performance degradation when the CPU frequency is reduced and may achieve significant power/energy savings—for example, in one test system, a reduction in CPU frequency by about 58% yielded a 37% power savings and a 36% energy savings, with only a 1.6% performance loss. On the other hand, a primarily compute-bound application such as imagick may suffer much more performance degradation when the CPU frequency is reduced and may not achieve significant energy savings—for example, in one test system, a 52% reduction in CPU frequency results in 51% power savings, but at the cost of a 7.7% energy increase and a 53% performance drop. Consequently, some approaches to optimizing CPU frequency may attempt to account for differences between applications by characterizing the applications based on their sensitivity to CPU frequency and then controlling the CPU frequency based on which type of application is being executed. In other words, “optimal” frequencies are determined on a per-application basis. For example, if the application being executed is characterized as compute-bound, then the CPU frequency may be reduced less (or not at all) to avoid performance degradation, whereas if the application is characterized as memory-bound, the CPU frequency may be reduced more to save power and energy with little performance degradation. This may be referred to as application-aware power/energy optimization.

However, application-aware power/energy optimization may not always produce the best results. In particular, the response of a system to CPU frequency may vary not only from one application to another application, but also within different regions (e.g., functions, routines, loops, or other regions) of the same application. Many (perhaps most) applications contain some mixture of memory-bound regions and compute-bound regions—very rarely is an application uniformly memory bound or uniformly compute-bound. Even in applications that are, as a whole, primarily compute-bound or memory-bound, there is very often at least one region (sometimes multiple regions) of the application that do not follow the trend of the application as a whole. Accordingly, if a single CPU frequency is set for the entire application, this frequency is very likely to be sub-optimal for at least some regions of the application.

For example, if under an application-aware optimization approach an application is characterized as memory-bound and thus a reduced frequency is set for the application, this may produce the desired power savings when the memory-bound regions are executed. But whenever one of the compute-bound regions of the application is executed, the performance of the system will suffer due to the lower frequency. Thus, the overall performance of the system (i.e., the time needed to complete the job) will be degraded somewhat. Conversely, if under an application-aware optimization approach an application is characterized as compute-bound and thus a higher frequency is set, this may allow for good performance during execution of the compute-bound regions. But whenever one of the memory-bound regions is executed the higher frequency will result in unnecessary electricity consumption. Thus, the electrical efficiency of the system will be somewhat lower. Accordingly, application-aware optimization may not achieve all of the electricity savings and/or system performance that is theoretically possible.

To address these and other issues, disclosed herein is a region-aware power and energy optimization technique, which may be implemented in a region-aware power and energy regulator. In the region-aware power and energy optimization technique, compute-boundedness parameters (% CB) are determined, respectively, for individual regions (e.g., functions, routines, etc.) of the application, and then optimal CPU parameters (e.g., CPU frequencies, power cap, etc.) are determined, respectively, for the individual regions based on their compute-boundedness. A highly compute-bound region may be given a higher frequency (or higher power cap, etc.) to mitigate performance degradation, whereas a less compute-bound region may be given a lower frequency (or lower power cap, etc.) to save electricity. Throughout execution of the application, the CPU's parameters (e.g., frequency) may be changed repeatedly to different values, depending on the region currently being executed so that, at any given time, the current CPU parameter (e.g., frequency) is equal to the optimal parameter (e.g., optimal frequency) for the current region being executed. This allows for even greater performance and electrical efficiency to be achieved than would be possible under the application-aware optimization approaches.

In some examples, the compute-boundedness parameters % CB for the regions and the associated optimal frequencies may be determined during runtime as the application is executed. Thus, there is no need to pre-characterize the platform or application. In addition, the region-aware power and energy optimization techniques do not require a user to attempt to analyze or characterize the applications or regions thereof, allowing the approach to be much more user friendly (approaches which, for example, rely on users to define or characterize aspects of the application are rarely if ever put into practice, as users tend to not want to do such extra work when they are submitting jobs).

In some examples, the compute-boundedness parameter (% CB) of a region quantifies the compute-boundedness of the region. For example, % CB may be a percentage value between 0 and 100, with a value of 100% meaning the region is purely compute-bound and 0% meaning the region is not at all compute-bound (i.e., purely memory bound). In some examples, to determine the compute-boundedness parameter % CB for a given region, the number of instructions-per-second (IPS) executed by the processor during multiple sampling periods associated with different CPU frequencies is determined during execution of the given region, and the compute-boundedness parameter % CB of a given region is determined based on the IPS measurements. For example, a first IPS measurement IPS_{high} may be sampled while the CPU frequency is at a predetermined high value Freq_{high}, and then a second IPS measurement IPS_{low} may be sampled while the CPU frequency is at a predetermined low value Freq_{low} (both being sampled during execution of the same given region), and the compute-boundedness parameter % CB for the given region may be determined based on IPS_{high} and IPS_{low}—for example, an equation that relates IPS_{high}, IPS_{low}, Freq_{high}, and Freq_{low} as input variables to compute boundedness parameter % CB as an output variable (e.g., eq. 1 described below) may be evaluated to determine % CB.

The IPS is a metric which is easily obtainable on nearly every (if not every) platform, and thus the region-aware optimization techniques can be used in nearly any type of computing system, in contrast to many machine-learning approaches that rely on hardware counters which are specific to one type of system (e.g., specific to an Intel processor or specific to an AMD processor). This, among other things, allows the region-aware power and energy optimization techniques to be vendor- and platform-independent.

In some examples, the optimal frequency for a given region is determined based not only on the compute-boundedness parameter % CB for that region, but also based on a performance degradation parameter (PD). The performance degradation parameter PD represents an acceptable level of performance degradation relative to the default performance that would be achievable at the default CPU frequency (without any adjustments to save electricity). For example, a PD of 5% would indicate that a 5% performance degradation is acceptable—i.e., a performance of 95% of the default level of performance. In some examples, the optimal frequency for the given region may be determined by evaluating an equation that relates % CB and PD as input variables to an optimal frequency as an output variable (e.g., eq. 2 described below). In some examples, the performance degradation parameter PD may be specified by a user, for example when they submit a job to be performed. In this manner, the region-aware optimization is easily customizable to strike a desired balance between electricity savings and performance.

In some examples, a simple algebraic equation (see eq. 1, described below) may be used to determine % CB based on the IPS values and another simple algebraic equation (see eq. 2, described below) may be used to determine the optimal frequency based on % CB and PD, and thus the optimal frequency may be determined very quickly and easily (e.g., on the order of 100 ms). Thus, the approach is relatively light weight in terms of computational overhead and is agile enough to react to quickly changing regions of an application. In contrast, machine-learning based approaches (such as the application-aware approaches) tend to be much more computationally intensive and take much longer to converge on a solution (e.g., on the order of seconds, minutes, or longer depending on the complexity of the model), making such approaches less useful in some contexts.

In addition to setting the CPU core frequency based on % CB as described above, some examples may include further region-based optimizations. For example, in some implementations an uncore frequency may also be adjusted for some regions based on % CB. The uncore frequency refers to a frequency of portions of the CPU other than the cores, which may include L3 cache, memory controller, etc. In some examples, uncore frequency may be reduced in regions which have a high % CB.

In some examples, the region-aware power/energy regulator is also aware of Message Passing Interface (MPI) regions and is configured to optimize CPU frequency specifically for these regions in a manner that may differ slightly from other regions. MPI is a message-passing standard for parallel computing architectures, such as HPC systems. Applications configured to utilize MPI, such as many HPC applications, may be referred to sometimes as MPI applications. During the execution of such an application, one process may occasionally need to communicate with another process using an MPI function. Due to the special nature of these functions, if they were characterized using the approach described above without any special considerations, erroneous results may sometimes be received. For example, some MPI wait functions may frequently poll the other processes while waiting for data, which increase the measured IPS (as each polling cycle includes execution of instructions), and therefore the MPI wait functions may be determined to have a high compute-boundedness % CB, which would result in a high frequency being assigned during the MPI calls. However, no useful work is being done during the MPI wait despite the high IPS, and therefore the high frequency would be wasteful. Accordingly, examples disclosed herein may override the standard optimization behavior when such an MPI wait function is encountered and may instead set the CPU frequency to a predetermined low value during this function. Moreover, in some examples, this changing of the CPU frequency to the low value for an MPI wait function may be carried out only when certain criteria is met, such as when the MPI wait function is expected to have a duration longer than a specified minimum.

Turning now to the figures, various devices, systems, and methods in accordance with aspects of the present disclosure will be described.

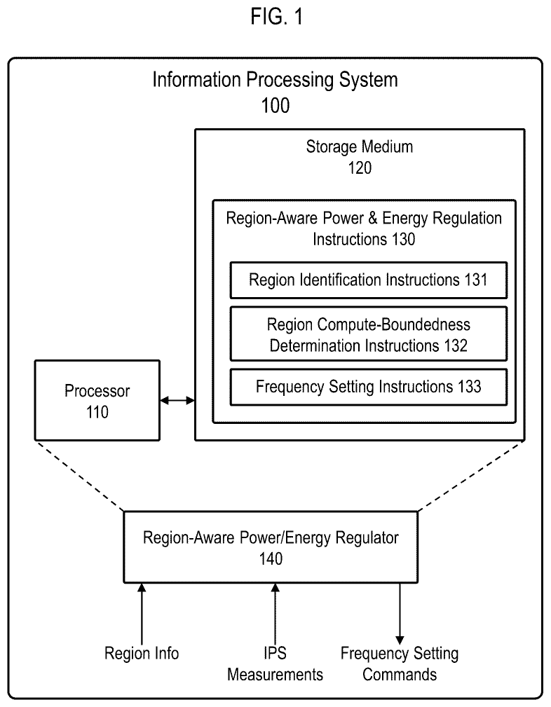

FIG. 1 is a block diagram schematically illustrating an information processing system 100. It should be understood that FIG. 1 is not intended to illustrate specific shapes, dimensions, or other structural details accurately or to scale, and that implementations of the information processing system 100 may have different numbers and arrangements of the illustrated components and may also include other parts that are not illustrated.

As shown in FIG. 1, the information processing system 100 comprises a processor 110 and a storage medium 120 communicably connected to the processor 110. The processor 110 may comprise a central processing unit (CPU), system-on-chip (SoC), or any other hardware processing resource. The storage medium 120 comprises a non-transitory computer readable medium such as a hard-disk drive (HDD), solid-state drive (SSD), flash memory, random-access-memory (RAM), or any other non-transitory computer readable medium.

The storage medium 120 stores region-aware power & energy regulation instructions 130, which are executable by the processor 110. When the processor 110 executes these instructions 130, a region-aware power/energy regulator 140 is instantiated. The region-aware power/energy regulator 140 performs operations described herein related to region-aware power/energy optimization and regulation. This regulation comprises, among other things, characterizing individual regions of an application (e.g., an HPC application) being executed by a CPU and determining optimal CPU frequencies for the individual regions which the CPU is to use during execution of the region.

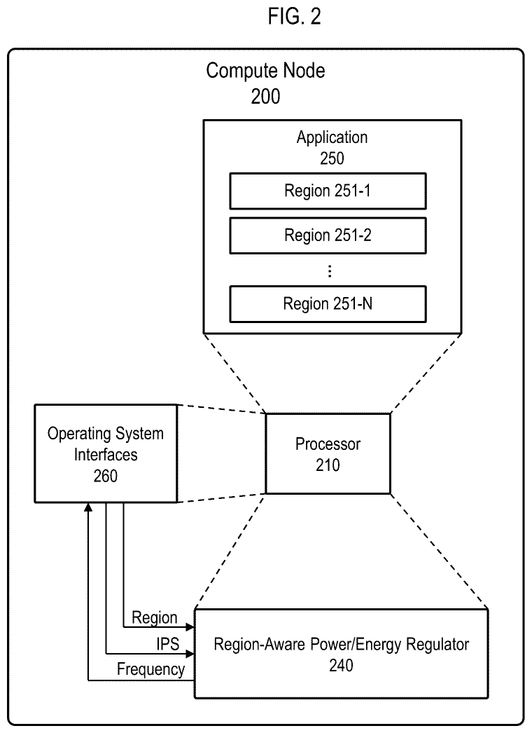

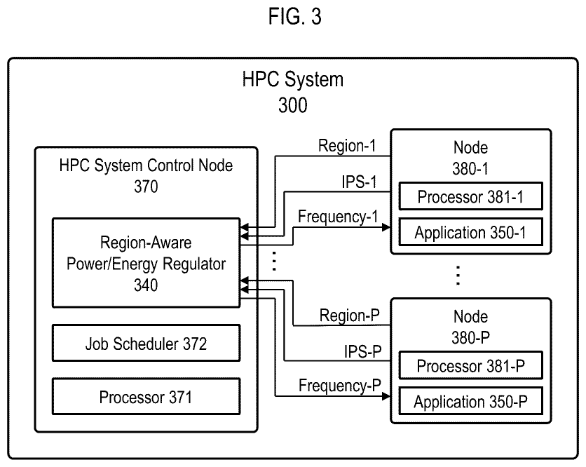

The CPU that is executing the application may be the processor 110 itself, or the CPU may be part of some other device which the system 100 controls and monitors. For example, FIG. 2 illustrates one example implementation for the system 100 in the form of compute node 200, wherein the same processor 210 instantiates both the application 250 and regulator 240. As another example, FIG. 3 illustrates another example implementation of the system 100 in the form of HPC system 300 in which the processor that instantiates the regulator 340 is different from the processors executing the applications 350.

Returning to FIG. 1, the instructions 130 comprise region identification instructions 131. The region identification instructions 131, when executed, cause the regulator 140 to identify the region of an application that is currently being executed. As used herein, a “region” of an application is defined as: (A) any function (also known as a routine or sub-program) of the application or any section of the application equivalent to a function; or (B) the smallest discrete section of the application that can be identified and be characterized. Examples of regions includes functions (routines, sub-programs), loops, sub-routines, etc. For example, region information may be monitored (periodically received or requested) by the regulator 140, wherein the region information indicates the current region being executed. In some examples, the region information may comprise a current address of an instruction pointer of the process, which may be cross-referenced against known addresses of regions of the application to determine the region currently being executed.

For example, the regulator 140 may begin by identifying which regions the application contains and saving addresses associated with these regions for fast lookup. For example, if the application contains identifiable functions, the regulator 140 may determine and store the addresses of each of these functions. The regulator 140 may also, in some examples, identify other types of regions of the application, such as sections of contiguous memory of a predetermined size (e.g., the smallest size that can be characterized) and store addresses associated with these regions. The regulator 140 may then begin continuously monitoring the application to identify the current region by retrieving the current instruction pointer at a predetermined interval. By default, the regulator 140 identifies the current region as being either (a) the function containing the address of the instruction pointer, if the address of the instruction pointer is associated with a function, or (b) the section of contiguous memory addresses containing the address of the instruction pointer, if the address of the instruction pointer is not associated with a function. By default, the size of the contiguous section of memory addresses is of a predetermined size (e.g., the smallest size that can be characterized). The interval at which the instruction pointer is monitored may be as short as possible to account for entering/leaving different regions, such as every 50 us in some examples.

In some examples, obtaining the region addresses involves parsing the binary's symbol table, with more complications when there are shared libraries. Since shared libraries are loaded at different addresses for each process (and for each subsequent run), the regulator 140 first accesses the process's address space using a tool such as ptrace. A linked list of shared library ELF file information can be found at the loaded application's linkmap, whose address is located in the Global Offset Table (GOT). Then, each ELF file's dynamic symbol table can be parsed for function names and addresses.

If multiple regions comprising adjacent sections of contiguous addresses have been characterized and these regions have similar % CB, then these adjacent sections can be merged together into a single region. In this context, similarity may be defined as their % CB being different by less than a threshold amount. The threshold amount may be predetermined or user definable. In some examples, the threshold amount is 5%. In some examples, the threshold amount is 10%.

The region identification instructions 131 may also be configured to cause the regulator 140 to determine whether the identified region needs to be characterized. (Characterized, in this context, refers to determining a compute boundedness parameter for the region). Some regions may have already previously been characterized, in which case further characterization is not needed. Other regions may not have been characterized but may be omitted from characterization due to one or more exceptions. For example, in some implementations only regions which are deemed significant are characterized. In some examples, a region is deemed significant if the amount of time that has been spent in the region surpasses a predetermined threshold. In some examples, the regulator 140 uses Linux perf_event to determine when a region is encountered and how much time has been spent in that region. By using the PERF_COUNT_SW_CPU_CLOCK counter, the regulator 140 can retrieve the current instruction pointer reliably at a regular time interval (e.g., 50 μs), as well as measure the approximate time spent in each region. This also allows the regulator 140 to know when to periodically resample regions, which can be important for long-running applications.

The instructions 130 further comprise region compute boundedness determination instructions 132. These instructions 132 may be executed when it is determined that a given region needs to be characterized. The region compute boundedness determination instructions 132 comprise instructions to determine a compute-boundedness parameter % CB for the current region being characterized based on IPS measurements. In some examples, the compute-boundedness parameter % CB of a region quantifies the compute-boundedness of the region. For example, % CB may be a percentage value between 0 and 100, with a value of 100% meaning the region is purely compute-bound and 0% meaning the region is not at all compute-bound (i.e., purely memory bound).

In some examples, when it is determined that a given region needs to be characterized, the regulator 140 will engage a sampling procedure in which the CPU frequency is set to a predetermined value for the duration of a sampling period (in which the region continues being executed) and the IPS is measured after completion of the sampling period. For example, a first IPS measurement IPS_{high} may be sampled while the CPU frequency is at a predetermined high value Freq_{high}, and then a second IPS measurement IPS_{low} may be sampled while the CPU frequency is at a predetermined low value Freq_{low} (both being sampled during execution of the same given region). The compute-boundedness parameter % CB for the given region may be determined based on IPS_{high} and IPS_{low}, for example by evaluating the following equation:

$$\% {CB}_{n} = 100 \% \cdot \frac{\frac{{IPS}_{high \_ n}}{{IPS}_{low \_ n}} - 1}{\frac{{Freq}_{high \_ n}}{{Freq}_{low \_ n}} - 1} . \qquad ( eq . 1 )$$

In equation 1, % CBₙ is the compute boundedness parameter for the n^{th} region of the currently executing application (in this context, “n” is an arbitrary index used herein to identify a given region), IPS_{high_n} is the high IPS measurement taken for the n^{th} region, IPS_{low_n} is the low IPS measurement taken for the n^{th} region, Freq_{high_n} is the high frequency at which IPS_{high_n} was sampled, and Freq_{low_n} is the low frequency at which IPS_{low_n} was sampled. % CBₙ is limited to values between 0 and 100%. In some examples, a memory boundedness parameter % MB may also be calculated, wherein % MB=100%−% CB. The IPS ratio in equation 1 informs how the change in frequency has affected performance, which is then scaled by the frequency ratio. To give some intuition for this formula, if the frequency ratio is 1.5 (i.e., 3 GHZ/2 GHz), but the IPS ratio is 1.25 (i.e., performance at 3 GHz is only 25% faster than at 2 GHZ), then the regulator 140 considers that to be 50% compute bound. Moreover, this metric can dynamically adapt to the platform capabilities, i.e., if a different processor has less memory bandwidth per core then the application may become more memory bound and the IPS ratio will be smaller.

In some examples, Freq_{high} is the turbo frequency and Freq_{low} is any lower frequency (for example, the highest non-turbo frequency).

The IPS measurements may be received, in some examples, from the processor which is executing the application (or, more specifically, from an operating system operating on the processor executing the application). This processor that is executing the application may be the same as processor 110 in some examples, or different from the processor 110, as already noted above. In some examples, the regulator 140 uses Linux perf_event interface to access the IPS measurands and as a tool to obtain the instruction pointer and timestamp with each sample. For example, in some implementations, to measure IPS, the regulator 140 may define the sampling period in terms of a defined number of instructions and then may measure how long it takes to execute that defined number of instructions. This results in a number which represents the seconds per instructions, which is the inverse of IPS. IPS can thus be calculated as 1 divided by this number. For example, the sampling period may comprise 100,000 instructions, and if a given sampling period takes X seconds to complete, then the IPS for that sampling period is 100,000/X. The regulator 140 may utilize the PERF_COUNT_HW_INSTRUCTIONS performance counter to determine when a predetermined number of instructions have been executed. Perf also allows for tracking a specific core or process. With the Linux ps command, the regulator 140 can automatically identify both the core and pid of any process running the target application, which is then supplied to perf_event.

In some examples, the sampling of IPS_{high} and IPS_{low} are conducted in sequence during a single given execution of a region being characterized. In other examples, the sampling of IPS_{high} and IPS_{low} may be spread out over multiple different instances of execution of the region to avoid too frequent sampling. For example, in some implementations one of IPS_{high} and IPS_{low} is sampled the first time a region is executed and the other of IPS_{high} and IPS_{low} is sampled the next time the region is executed. Moreover, in some examples, multiple IPS_{high} samples and/or multiple IPS_{low} samples may be gathered, and the values used in equation 1 may be a statistical aggregation (e.g., average) of the values.

As noted above, in some implementations, not every region is deemed significant for purposes of determining if it should be characterized. This limitation may be imposed in some implementations to avoid performing the sampling too often. Sampling too often can be detrimental. If too much high sampling is done, it may eat into power/energy savings if the region is memory-bound. Similarly, if too much low sampling is done, it may hurt performance if the region is compute-bound. In some implementations, the threshold for significance may be those regions that take up at least 5% of the current runtime. Moreover, a significant region will sometimes only lack enough of one type of sample (high or low), so ‘downtime’ can be further reduced by performing only high sampling if there aren't enough high samples or vice versa.

The instructions 130 further comprise frequency setting instructions 133. The frequency setting instructions 133 comprise instructions to determine an optimal CPU frequency for the currently executing region based on its compute-boundedness % CB and instructions to command the system 100 to set the CPU frequency to the optimal frequency. A highly compute-bound region may be given a higher frequency to mitigate performance degradation, whereas a less compute-bound region may be given a lower frequency to save electricity. Throughout execution of the application, the CPU's frequency may be changed repeatedly to different values, depending on the region currently being executed so that, at any given time, the current CPU frequency is equal to the optimal frequency for the current region being executed.

In some cases, the optimal frequency for a region will already be known, e.g., because the region has already been characterized, in which case the regulator 140 may generate frequency setting commands to set the frequency to this already known optimal frequency. In other cases, the optimal frequency for the region is not yet known, in which case the optimal frequency may be calculated based on % CB.

In some examples, the optimal frequency for a given region is determined based not only on the compute-boundedness parameter % CB for that region, but also based on a performance degradation parameter (PD). The performance degradation parameter PD represents an acceptable level of performance degradation relative to the default performance that would be achievable at the default CPU frequency (without any adjustments to save electricity). For example, a PD of 5% would indicate that a 5% performance degradation is acceptable—i.e., a performance of 95% of the default level of performance. Thus, in some examples, the optimal frequency for the given region may be determined by evaluating an equation that relates % CB and PD as input variables to an optimal frequency as an output variable. For example, in some implementations the optimal frequency is given by the following equation:

$${Freq}_{n} = \frac{{Freq}_{high \_ n}}{1 + \frac{PD}{\% {CB}_{n} ( 1 - PD )}} \qquad ( eq . 2 )$$

In equation 2, Freqₙ represents the optimal or ideal frequency for the n^{th} region, Freq_{high_n} represents the highest (turbo) frequency for the n^{th} region, PD is the performance degradation parameter, and % CBₙ is the compute boundedness parameter for the n^{th} region. In some examples, the performance degradation parameter PD may be specified by a user, for example when they submit a job to be performed. In this manner, the region-aware optimization is easily customizable to strike a desired balance between electricity savings and performance.

Equation 2 may be obtained based on the insight that compute-boundedness % CB reflects the sensitivity of a region's performance to frequency variations. That is, the time to complete a given amount of work may vary proportionally to the CPU frequency, with the % CB serving as the constant of proportionality. Intuitively, if the region is wholly memory bound (% CB=0), then any variation in CPU frequency will have no effect on performance (time to completion). Conversely, if the region is wholly CPU bound, then variation in CPU frequency will affect performance in a 1-to-1 manner. From these intuitive principles, the following functional relationship can be deduced:

$$\frac{{Time}_{low}}{{Time}_{high}} = \% CB ( \frac{{Freq}_{high}}{{Freq}_{low}} - 1 ) + 1 \qquad ( eq . 3 )$$

In equation 3, Time_{low} refers to the time to complete a given amount of work at the low frequency Freq_{low} and Time_{high} refer to the time to complete the same given amount of work at the high frequency Freq_{high}. In addition, the performance degradation parameter PD can be related to Time_{high} and Time_{low} as follows:

$$\frac{{Time}_{high}}{{Time}_{low}} = 1 - PD \qquad ( eq . 4 )$$

Combining equations 3 and 4, rearranging the result, and substituting Freqₙ for Freq_{low} yields equation 2.

In some implementations, the instructions 133 may cause the regulator 140 to optimize another CPU parameter for individual regions based on the respective % CB of those regions, wherein variation of the other CPU parameter affects performance and power/energy consumption dependent (at least in part) on the compute-boundedness of the region. Examples of such other CPU parameters include a power cap parameter, a thermal limit parameter (e.g., the CPU temperature at which throttling begins and/or boosting/turbo behavior is curtailed), or others. Often, these other CPU parameters may affect performance and electricity consumption by, in part, indirectly limiting CPU frequencies, which may be useful in systems where controlling CPU frequency directly is difficult or otherwise undesirable. In some implementations, the optimization of the other CPU parameter may be done in addition to optimizing frequency. In some implementations, the optimization of the other CPU parameter may be done in lieu of optimizing frequency. The other CPU parameter may be optimized using equation 2 except with values of the other CPU parameter substituted for Freq_{high} and Freq_{low} (e.g., a high power cap substituted for Freq_{high}, and a low power cap substituted for Freq_{low}).

Once the optimal frequency Freqₙ is determined for the n^{th} region, the frequency setting instructions 133 may thereafter instruct the CPU to the use the optimal frequency Freqₙ whenever the n^{th} region is executed. In some implementations, Dynamic Voltage Frequency Scaling (DVFS) is used to adjust the frequency of the processor. In some implementations, the regulator 140 uses the CPUFreq interface to modify CPU frequency. Specifically, the cpupower frequency-set command allows root users to set the maximum frequency for all cores all at once, rather than modifying individual sysfiles for each core. The current frequency can also be checked with cpupower or by reading the corresponding sysfile. Importantly, changing frequencies does not happen instantly and the regulator 140 must take into account switching latency. For example, in an Intel Sapphire Rapids test system, CPUFreq specifications have a 10 μs transition latency, and in an AMD Genoa test system, the CPUFreq specifications have an 8 μs transition latency.

Furthermore, the calculated ideal frequency may not be an available frequency option in the CPUFreq interface in some cases. In examples, in which the available frequency settings do not match the calculated optimal frequency perfectly, the next closest available frequency setting may be used as the optimal frequency setting. In some cases, however, if the available frequency settings are too coarse (for example, in the Genoa test system, the available frequency options are at a coarse granularity of 3.7 GHZ (turbo), 2.4 GHZ, 1.9 GHZ, and 1.5 GHZ), rather than using the next closes available frequency setting, the optimal frequency may be emulated by alternating between the next lowest and the next highest frequency settings at a timing ratio that results in the weighted average frequency equaling the optimal frequency.

In those examples in which another CPU parameter is optimized for the region based on % CB of the region, the instructions 133 may comprise instructions to command the system running the application to set the other CPU parameter to the determined optimal value for the parameter.

In addition to setting the CPU core frequency based on % CB as described above, in some examples the regulator 140 may also include instructions to determine an optimal uncore frequency for the individual regions and set the uncore frequency based thereon. The uncore frequency refers to a frequency of portions of the CPU other than the cores, which may include L3 cache, memory controller, etc. In some examples, uncore frequency may be reduced in regions which have a high % CB. For example, in some implementations, the uncore frequency may be set based on the compute-boundedness parameter % CB similar to the CPU frequency, except that the relationship between uncore frequency and % CB may be reversed as compared to the relationship between CPU frequency and % CB. In other words, if a region has low % CB (i.e., is highly memory bound), then the uncore frequency is set high to avoid loss of performance, but if a region has high % CB (i.e., is highly compute bound), then uncore frequency can be set low to save power without significant loss of performance. In some examples, uncore frequency is set using the following equation:

$${Freq}_{uncore \_ n} = \frac{{Freq}_{uncore \_ max}}{1 + \frac{PD}{( 1 - \% {CB}_{n} ) ( 1 - PD )}} \qquad ( eq . 5 )$$

In some examples, the region-aware power/energy regulator 140 is also aware of Message Passing Interface (MPI) functions and is configured to optimize CPU frequency specifically for these functions in a manner that may differ slightly from other functions. In some examples, the regulator 140 may override the standard optimization behavior when an MPI wait function is encountered and may instead set the CPU frequency to a predetermined low value during this function. Moreover, in some examples, this changing of the CPU frequency to the low value for an MPI wait function may be carried out only when certain criteria is met, such as when the MPI wait function is expected to have a duration longer than a specified minimum.

In addition, MPI applications can assign different processes (ranks) to perform different tasks, for instance using subcommunicators. Thus, there may be the case where Rank A is in a compute-bound region and Rank B is in a wait function, and if the regulator 140 is monitoring Rank B and lowers the CPU frequency of all cores, then Rank A will be adversely affected. One solution to this, which is used in some implementations, is to utilize per-core DVFS, where CPU frequency is only changed for a specific core rather than the entire socket. For example, per-core DVFS has been available on most Intel platforms since the integration of per-core voltage regulators in Haswell. To make use of per-core DVFS, the system 100 can deploy multiple regulator 140 processes, where each regulator 140 process monitors a single MPI rank. In this manner, each regulator 140 process will still characterize functions/phases appropriately but any frequency change will not affect other ranks, and the lightweight nature of the regulator 140 will minimize overhead. In other implementations, per-core DVFS may not be available, in which case when a subcommunicator call is detected, the regulator 140 may run the CPU at the highest CPU frequency.

The regulator 140 may allow for substantial power and energy savings while still allowing desired performance levels to be maintained. For example, in two test systems (one Intel Saphire Rapids system and one AMD Genoa system), the regulator 140 achieved promising results, which are summarized below.

For the Intel test system, the regulator 140 achieved 10-20% energy and power savings with about 5% performance loss for memory bound applications. At most, a 7% performance loss was seen with some applications (e.g., lbm), accompanied by 33% energy and 38% power savings. Importantly, other approaches do not detect these available savings and derive nearly the same results as the baseline. For more compute-bound applications, the regulator 140 is able to save 5-10% energy by improving performance in compute-bound applications. For more mixed applications, the regulator 140 see results mostly on par with the baseline, with about <3% performance loss, but some applications see significant improvements in energy savings such as 5% and 9% in xz and xalancbmk.

For the AMD test system, most compute-bound applications reach within 3% of the desired performance level, with power savings proportional to the allowed performance loss and about the same relative energy consumption as the baseline. The more memory-bound applications tend to save about 30% in power and energy and reach 95%+ relative performance. The more mixed applications have a greater variability in achieving the appropriate performance degradation, but overall save power/energy.

Turning now to FIG. 2, an example compute node 200 will be described. The compute node 200 is one example implementation of the information processing system 100 of FIG. 1. Some components of the compute node 200 correspond to (e.g., are similar to or configurations of) components of the system 100, and these components are given similar reference numbers having the same last two digits, such as 110 and 210. The descriptions of the components of the system 100 are applicable to the similar components of the node 200 unless indicated otherwise or logically contradictory, and duplicative descriptions are omitted. Although the compute node 200 is one example of the system 100, the system 100 is not limited to the compute node 200.

The compute node 200 represents an example implementation of the system 100 in which the same processor that is running the application for which optimization is sought is also the processor that instantiates the region-aware power/energy regulator. Thus, in FIG. 2, the processor 210 instantiates both the application 250 and the regulator 240. In some examples, the compute node 200 may be an individual compute node of a larger HPC system, wherein a job is processed concurrently by the entire HPC system with each compute node (including the compute node 200) executing applications (including application 250) to concurrently perform portions of the job. In some examples, the compute node 200 may be an individual computing device (e.g., server) which is not necessarily part of any larger HPC system.

The application 250 comprises multiple regions, including regions 251-1 to 251-N, wherein N in any integer equal or greater than 2. The regions 251 may be, in some examples, functions. In other examples, the regions 251 may be sections of contiguous memory addresses. In other examples, some regions 251 may be functions and others sections of contiguous memory addresses. The regulator 240 is configured to determine optimal frequencies for the regions 251-1 to 251-N as described above in relation to regulator 140. In this example, the region identification information (e.g., instruction address pointer) and IPS measurement information are provided to the regulator 240 by operating system interfaces 260, and the CPU frequency setting commands are sent from the regulator 240 to the operating system interfaces 260. The operating system interfaces 260 may be part of the operating system, BIOS, firmware, or other system management systems of the node 200 and may be instantiated by the processor 210. The operating system interfaces 260 may include perf_event, CPUFreq, and the other interfaces and tools mentioned above in relation to regulator 140.

Note that the node 200 also comprises a storage medium (similar to the storage medium 120) with instructions (similar to the instructions 130) to instantiate the regulator 240, but these elements are omitted from view in FIG. 2.

Turning now to FIG. 3, an example HPC system 300 will be described. The HPC system 300 is one example implementation of the information processing system 100 of FIG. 1. Some components of the HPC system 300 correspond to (e.g., are similar to or configurations of) components of the system 100, and these components are given similar reference numbers having the same last two digits, such as 140 and 340. The descriptions of the components of the system 100 are applicable to the similar components of the HPC system 300 unless indicated otherwise or logically contradictory, and duplicative descriptions are omitted. Although the HPC system 300 is one example of the system 100, the system 100 is not limited to the HPC system 300.

The HPC system 300 represents an example implementation of the system 100 in which the application for which optimization is sought and the region-aware power/energy regulator are instantiated by different processors, specifically by different processors of different nodes of an HPC system.

Specifically, the HPC system 300 comprises a plurality of compute nodes 380-1 to 380-P (where P is an integer equal to or greater than 2) that perform the computational tasks of jobs submitted to the HPC system 300, and an HPC system control node 370 that controls operations of the system as whole, including orchestrating the jobs. In some examples, the HPC system control node 370 is also a compute node that is tasked with system control regions, whereas in other examples the system control node 370 is a node dedicated solely to system control regions. Each compute node 380 comprises a processor 381 configured to execute an HPC application 350 (e.g., node 380-1 comprises processor 381-1 executing application 350-1, and so on). Each HPC application 350 comprises multiple regions.

The HPC system control node comprises a processor 371 configured to instantiate the region-aware power/energy regulator 340. The regulator 340 may be similar to the regulator 140 described above. In this example, the regulator 340 receives the region identification information and IPS measurements from external sources, namely from nodes 380-1 to 380-P. For example, the operating system interfaces of these nodes may provide this information to the regulator 340. The node 380-1 may provide region identification information region-1 indicative of its currently executing region and IPS measurements IPS-1 measured based on its processor 381-1, and the regulator 340 may determine an optimal frequency for that region and send frequency setting instructions Frequency-1 to the node 380-1. Similarly, the node 380-P may provide region identification information region-P and IPS measurements IPS-P indicative of its currently executing region and corresponding IPS measurements, and the regulator 340 may return frequency setting instructions Frequency-P. In this manner, each node 380 may be frequency optimized individually based on its currently executing regions. In some examples, the same region may be executed on multiple nodes 380 (concurrently, or at different timings), and in some examples when this happens the optimal frequency which was determined for one node 380 may be applied to another node without having to characterize the region again for the other node 380—in other words, in some examples, the regulator 340 may reuse information learned with respect to one node 380 in the regulation of another node 380. In some examples, a single instance of regulator 340 may be responsible for optimizing each node 380 (receiving the input data from the node 380, characterizing regions of the node 380, and sending frequency setting commands to the node 380). In other examples, multiple instances of the regulator 340 may be instantiated, with each instance of the regulator 340 regulating a corresponding one of the nodes 380.

In some examples, the HPC system control node 370 also comprises a job scheduler 372. The job scheduler 372 receives job requests from users, which may include an indication of an application that is desired to be run and a data set to use for the application. The job scheduler 372 may then schedule the job on the nodes 380. The job scheduler 372 may, in some examples, be configured to allow a user to specify the performance degradation parameter PD when entering a job, and may communicate this information to the regulator 340 to enable the regulator 340 to use this information in calculating the optimal frequencies for regions of the application.

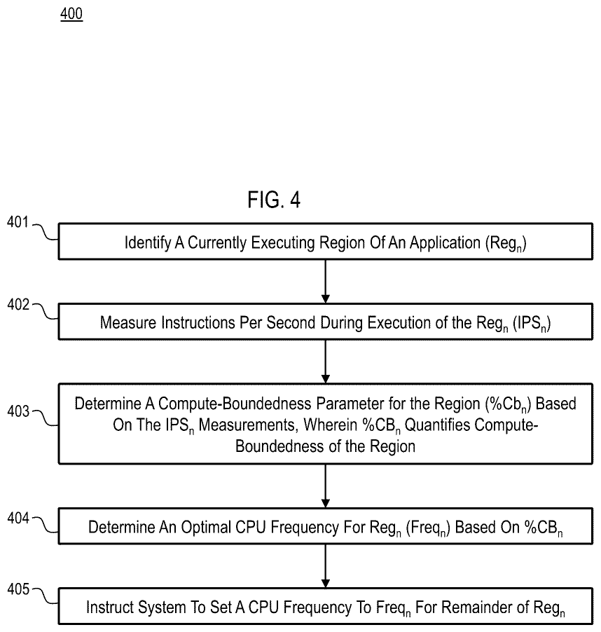

Turning now to FIG. 4, an example method 400 will be described. The method 400 may be performed by a region-aware power/energy regulator, such as any of the regulators 140, 240, and 340 described above. In some examples, region-aware power/energy regulation instructions 130 comprise instructions to perform operations of the method 400.

The method begins with block 401. In block 401, the regulator identifies a currently executing region of an application, which is denoted herein Regₙ (with “n” being an arbitrary index for identifying the region). This identification of the currently executing region may include, for example, looking up the current instruction address pointer and cross-referencing this with known addresses of the regions of the application. Block 401 may be performed periodically, in some examples, to update the identity of the currently executing region. The method then proceeds to block 402.

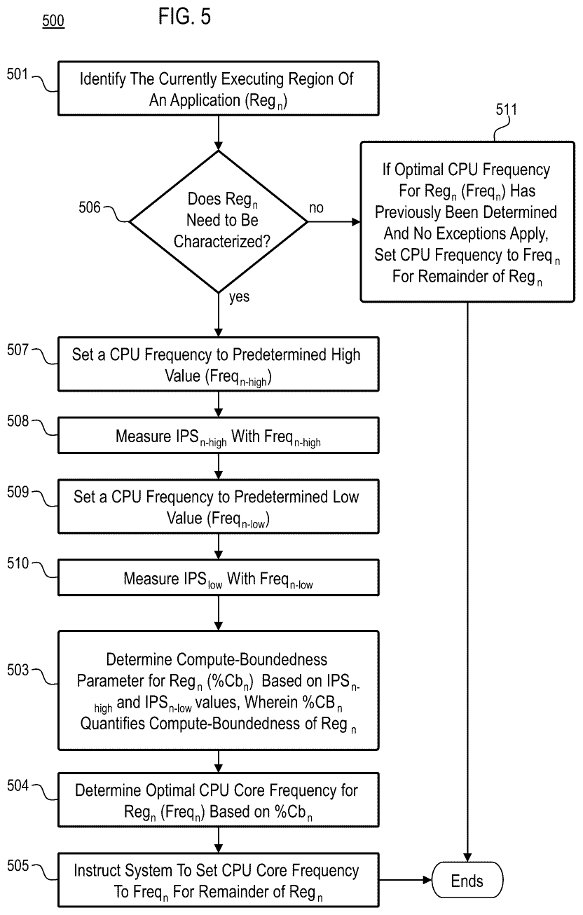

In block 402, the regulator measures instructions per second (IPS) values during the execution of the identified region Regₙ, and these IPS values may be denoted herein IPSₙ. The IPSₙ values may include multiple IPS measurements for Regₙ, including IPS measurements taken at different CPU frequencies, as explained in greater detail in relation to FIG. 5. The method then proceeds to block 403.

In block 403, the regulator determines a compute-boundedness parameter for the region Regₙ, denoted herein % CBₙ. This parameter % CBₙ is determined based on the IPSₙ measurements. % CBₙ quantifies the compute boundedness of the region. Specifically, compute boundedness refers to the sensitivity of the region to changes in CPU frequency, with regions whose performance (e.g., time to completion) is highly sensitive to CPU frequency being highly compute bound and regions whose performance is insensitive to CPU frequency being not-compute bound (i.e., memory bound). This sensitive may be characterized as a percentage, with 100% meaning 1-to-1 reductions in performance in response to reduction in CPU frequency (e.g., 50% drop in frequency produces 50% drop in performance), and 0% meaning no change in performance in response to reduction in CPU frequency. In some examples, determining % CBₙ in block 403 may include evaluating equation 1 as described above in relation to FIG. 1.

The method then proceeds to block 404. In block 404, the regulator determines an optimal CPU frequency for Regₙ, denoted herein Freqₙ, based on % CBₙ. For example, determining the optimal CPU frequency for Regₙ in block 404 may include evaluating equation 2 as described above in relation to FIG. 1. The method then proceeds to block 405.

In block 405, the regulator instructs the system executing the application to set the CPU frequency thereof to Freqₙ for the remainder of the execution of Regₙ.

Turning now to FIG. 5, another example method 500 will be described. The method 500 is an example implementation of the method 400.

The method 500 begins at block 501. In block 501, the currently executing region Regₙ is identified, similar to block 401 described above. The method then proceeds to block 506.

In block 506, the regulator determines if the region Regₙ needs to be characterized. For example, if Regₙ has previously been characterized, then it does not need to be characterized again. As another example, if an exception applies, then Regₙ does not need to be characterized. An exception may be, for example, that the region has not passed a significance threshold (e.g., for being executed more than a threshold amount of time). If the region Regₙ needs to be characterized, the process continues down the “yes” path to blocks 507-510. If the region Regₙ does not need to be characterized, the process continues down the “no” path to block 511.

Blocks 507-510 correspond to one implementation example of block 402 in method 400. In block 507, the regulator sets the CPU frequency to a predetermined high value Freqₙ-high. This may be, for example, a maximum (i.e., turbo) frequency. In block 508, with the CPU frequency still at Freqₙ-high and region Regₙ still executing, the IPS is measured, with the result being denoted herein IPSₙ-high. In block 509, the regulator sets the CPU frequency to a predetermined low value Freqₙ-low. This may be, for example, any value lower than the high frequency. In block 510, with the CPU frequency still at Freqₙ-low and region Regₙ still executing, the IPS is measured, with the result being denoted herein IPSₙ-low. Operations of blocks 507 to 510 may be performed in an order different than that shown, for example, with the low frequency IPSₙ-low being sampled before the high frequency IPSₙ-high. After blocks 507-510 are completed (in whichever order they happen to be performed), the process then continues to block 503.

In block 503, the regulator determines a compute-boundedness parameter % CBₙ for Regₙ based on IPSₙ-high and IPSₙ-low. For example, equation 1 may be used to determine % CBₙ. The process then continues to block 504.

In block 504, the regulator determines an optimal CPU core frequency for Regₙ, denoted herein Freqₙ, based on % CBₙ. For example, equation 2 may be used to determine Freqₙ.

In block 505, the regulator instructs the system to set the CPU core frequency to Freqₙ for the remainder of the execution of Regₙ.

In block 511 (which is reached from the “no” path after block 506), if an optimal CPU frequency Freqₙ for the region Regₙ was previously determined (i.e., Regₙ was previously characterized), and if no other exceptions apply, then the CPU core frequency may be set to the previously determined optimal value Freqₙ. In some implementations, an example of an exceptions that may prevent usage of the previously determined Freqₙ is the region Regₙ being an MPI wait region and the estimated duration of the region being less than a threshold value, in which case Freqₙ may be overridden and a predetermined high frequency may be used.

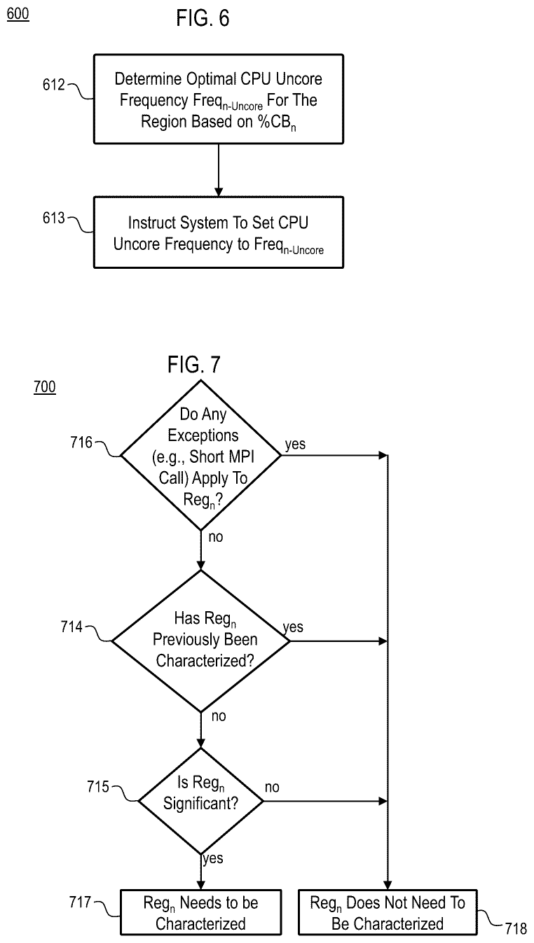

Turning now to FIG. 6, another method 600 will be described. The method 600 may be used in conjunction with any of the methods 400 and 500 to supplement the region thereof. In particular, method 600 may be performed after performance of blocks 403 or 503 in methods 400 or 500.

In block 612, an optimal CPU uncore frequency Freq_{n-uncore} is determined for the region Regₙ. The optimal CPU uncore frequency Freq_{n-uncore} may be determined based on % CB. More specifically, based on the memory boundedness % MB, which is equal to 1-% CB. For example, equation 5 described above may be used to determine Freq_{n-uncore}.

In block 613, the regulator instructs the system to set the CPU uncore frequency to Freq_{n-uncore}.

Turning now to FIG. 7, a method 700 is described. The method 700 compress an example implementation of block 506 of method 500.

In block 716, it is determined whether any exceptions apply to the currently executing region Regₙ. In some examples, an exception may include the region Regₙ being a short MPI call (e.g., an MPI wait region that is predicted to have a duration less than a specified threshold value). If an exception applies, then the process proceeds down the “yes” path to block 718, wherein it is determined that the region Regₙ does not need to be characterized. If no exception applies, then the process proceeds down the “no” path to block 714.

In block 714, it is determined if the region Regₙ has previously been characterized. In this context, previous characterization comprises determining a compute-boundedness parameter % CBₙ for Regₙ and determining an optimal frequency Freqₙ for Regₙ. In some examples, a partially completed characterization (e.g., some IPS data has been sampled, but not enough yet to calculate % CBₙ) would not count as the region previously being characterized, but instead only completed characterization would suffice. If Regₙ was previously characterized, the process continues down the “yes” path to block 718, wherein it is determined that the region Regₙ does not need to be characterized. If Regₙ was not previously characterized, then the process proceeds down the “no” path to block 715.

In block 715 it is determined if the region Regₙ is significant. In some examples, Regₙ is determined to be significant if the time spent executing the region exceeds a threshold. In some examples, this threshold is 5% of total execution time for the application. If Regₙ is not significant, the process continues down the “no” path to block 718, wherein it is determined that the region Regₙ does not need to be characterized. If Regₙ is significant, then the process proceeds down the “yes” path to block 717, wherein it is determined that the region Regₙ does need to be characterized.

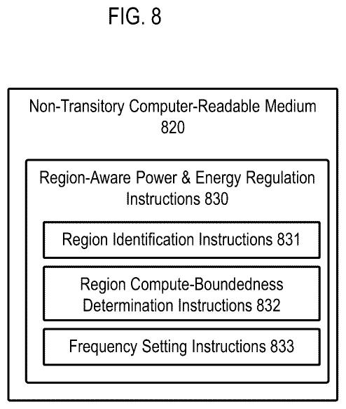

Turning now to FIG. 8, a non-transitory computer-readable medium 820 is described. The non-transitory computer-readable medium 820 comprises region-aware power & energy regulation instructions 830. The instructions 830 are similar to the instructions 130 described above and may include instructions to perform any of the methods 400, 500, 600, and 700 described above. In particular, the instructions 830 include region identification instructions 831 which may be similar to the instructions 131, region compute-boundedness determination instructions 832 which may be similar to the instructions 132, and frequency setting instructions 833 which may be similar to instructions 133.

In the description above, various types of electronic circuitry are described. As used herein, “electronic” is intended to be understood broadly to include all types of circuitry utilizing electricity, including digital and analog circuitry, direct current (DC) and alternating current (AC) circuitry, and circuitry for converting electricity into another form of energy and circuitry for using electricity to perform other regions. In other words, as used herein there is no distinction between “electronic” circuitry and “electrical” circuitry.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as connected may be electronically or mechanically directly connected, or they may be indirectly connected via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that regions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within +1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. An information processing system, comprising:
a processor;
a non-transitory storage medium comprising instructions executable by the processor to instantiate a region-aware power/energy regulator configured to,
periodically identify a region of an application which is currently being executed by a given processor out of a plurality of regions of the application;
measure the instructions per second (IPS) of the given processor during execution of the identified region;
determine a compute-boundedness parameter of the identified region based on the measured IPS;
determine an optimal frequency for the identified region based on the compute-boundedness parameter thereof; and
instruct the given processor to set a frequency of the given processor to the optimal frequency during execution of the identified region.

2. The information processing system of claim 1,
wherein measuring the IPS of the given processor comprises setting the frequency of the given processor to a high frequency and measuring the IPS to determine a high-frequency IPS, and setting the frequency of the given processor to a low frequency and measuring the IPS to determine a low-frequency IPS, and
wherein the compute-boundedness parameter is determined based on the high-frequency IPS and the low-frequency IPS.

3. The information processing system of claim 2,
wherein determining the compute-boundedness parameter of the identified region comprises evaluating an equation which relates the high frequency, the low frequency, the high-frequency IPS and the low-frequency IPS as input variables to the compute-boundedness parameter as an output variable.

4. The information processing system of claim 3,
wherein determining optimal frequency for the identified region comprises evaluating an equation which relates the compute boundedness parameter and a performance degradation parameter as independent variables to the optimal frequency as a dependent variable, and
wherein the performance degradation parameter is indicative of an acceptable level of performance degradation relative to a default performance.

5. The information processing system of claim 4,
wherein the regulator is configured to receive user input specifying the performance degradation parameter.

6. The information processing system of claim 1,
wherein the regulator is configured to determine an optimal uncore frequency for the identified region based on the compute-boundedness parameter thereof; and
instruct the given processor to set the uncore frequency of the given processor to the optimal frequency during execution of the identified region.

7. The information processing system of claim 1,
wherein the regulator is configured to determine if the identified region is an MPI call and, in response to determining the region is an MPI call, determine an expected duration of the MPI call.

8. The information processing system of claim 7,
wherein the regulator is configured to, if the identified region is an MPI call whose expected duration will not exceed a specified threshold, set the frequency of the given processor to a predetermined frequency regardless of a determined optimal frequency for the region.

9. The information processing system of claim 8,
wherein the regulator is configured to, if the identified region is an MPI call whose expected duration will exceed the specified threshold, set the frequency of the given processor according to the determined optimal frequency for the region.

10. The information processing system of claim 1,
wherein given processor executing the identified region is the processor.

11. The information processing system of claim 10,
wherein the information processing system comprises a compute node of a high-performance compute (HPC) system.

12. The information processing system of claim 1,
wherein given processor executing the identified region is distinct from the processor.

13. The information processing system of claim 12,
wherein the information processing system comprises a high-performance compute (HPC) system, the processor is part of a system controller node of the HPC system, and the given processor is part of a compute node of the HPC system.

14. A region-aware power/energy regulation method, comprising:
periodically identifying a region of an application which is currently being executed by a given processor out of a plurality of regions of the application;
measuring the instructions per second (IPS) of the given processor during execution of the identified region;
determining a compute-boundedness parameter of the identified region based on the measured IPS;
determining an optimal frequency for the identified region based on the compute-boundedness parameter thereof; and
instructing the given processor to set a frequency of the given processor to the optimal frequency during execution of the identified region.

15. The method of claim 14,
wherein measuring the IPS of the given processor comprises setting the frequency of the given processor to a high frequency and measuring the IPS to determine a high-frequency IPS, and setting the frequency of the given processor to a low frequency and measuring the IPS to determine a low-frequency IPS, and
wherein the compute-boundedness parameter is determined based on the high-frequency IPS and the low-frequency IPS.

16. The method of claim 14, further comprising:
determining an optimal uncore frequency for the identified region based on the compute-boundedness parameter thereof; and
instructing the given processor to set the uncore frequency of the given processor to the optimal frequency during execution of the identified region.

17. The method of claim 14, further comprising:
determining if the identified region is an MPI call and, in response to determining the region is an MPI call, determining an expected duration of the MPI call.

18. The method of claim 17,
wherein, in response to the identified region being an MPI call whose expected duration will not exceed a specified threshold, setting the frequency of the given processor to a predetermined frequency regardless of a determined optimal frequency for the region.

19. The method of claim 17,
wherein the regulator is configured to, in response to the identified region being an MPI call whose expected duration will exceed a specified threshold, setting the frequency of the given processor according to the determined optimal frequency for the region.

20. A non-transitory storage medium comprising instructions executable by a processor to instantiate a region-aware power/energy regulator configured to,
periodically identify a region of an application which is currently being executed by a given processor out of a plurality of regions of the application;
measure the instructions per second (IPS) of the given processor during execution of the identified region;
determine a compute-boundedness parameter of the identified region based on the measured IPS;
determine an optimal frequency for the identified region based on the compute-boundedness parameter thereof; and
instruct the given processor to set a frequency of the given processor to the optimal frequency during execution of the identified region.
